(19) United States
(12) Patent Application Publication
(10) Pub. No.: US 2006/0080072 A1
(43) Pub. Date: Apr. 13, 2006

(54) Optimized rendering of dynamic moving bodies

(75) Inventors: Lawrence M. Lachman, Plano, TX (US); Brett S. Chladny, Plano, TX (US)

Correspondence Address: BAKER BOTTS L.L.P., 2001 ROSS AVENUE, SUITE 600, DALLAS, TX, 75201-2980, US

(73) Assignee: Computer Associates Think, Inc.

(21) Appl. No.: 11/286,014

(22) Filed: Nov. 22, 2005

Related U.S. Application Data
(63) Continuation-in-part of application No. 10/386,732, filed on Mar. 12, 2003.
(60) Provisional application No. 60/630,283, filed on Nov. 23, 2004.

(51) Int. Cl. G06G 7/48

(52) U.S. Cl. 703/7

(57) ABSTRACT

Simulating a moving body from a plurality of observer views includes maintaining data representing the moving body. The data includes cells, where a cell is associated with one or more cell meshes. An observer view is associated with a corresponding observer position, a corresponding cell mesh, and an associated resolution. A cell mesh associated with an observer view for a cell is distinct from one or more other cell meshes associated with other observer views for the cell. The dynamic moving body is rendered in real time from the observer views according to the data representing the dynamic moving body.

### RELATED APPLICATIONS

This application claims benefit under 35 U.S.C. § 119(e) of U.S. Provisional Application Ser. No. 60/630,283, entitled “OPTIMIZED RENDERING OF DYNAMIC MOVING BODIES,” Attorney's Docket 0655/68849-CIP-PRO, filed Nov. 23, 2004, by Lawrence M. Lachman and Brett S. Chladny.

This application is a continuation-in-part of Ser. No. 10/386,732, filed Mar. 12, 2003 and entitled “VISUAL SIMULATION OF DYNAMIC MOVING BODIES”, the contents of which are incorporated by reference herein in its entirety.

### TECHNICAL FIELD

The present application relates to computer graphics. In particular, the application relates to simulation of dynamic moving bodies.

### BACKGROUND

Computer graphics techniques may operate to simulate stationary or moving bodies to generate a scene. A computer graphics technique may simulate a stationary scene, such as a terrestrial scene. The technique may perform view-dependent, locally adaptive terrain meshing that relies on a pre-defined multi-resolution representation. The technique, however, requires preprocessing of the terrain to achieve optimized real-time performance. Moreover, the technique requires a height map as a reference for the altitude of the points of the scene. Scenes that include rapid movement, however, typically have dynamically changing profiles. Accordingly, this technique may be not be readily adaptable for simulating movement in certain situations.

A computer graphics technique may simulate a dynamic scene, such as an ocean scene. The technique tethers the moving body an eyepoint, so the moving body can be rendered in only one viewport. Moreover, the technique provides inflexible modeling and rendering techniques for a moving body surrounding a moving eyepoint. Accordingly, improved methodologies for simulating a moving body may be needed in certain situations.

### SUMMARY OF THE DISCLOSURE

The present application provides a method for simulating a dynamic moving body. In one exemplary embodiment, a method for visually simulating a dynamic moving body from multiple observer views includes maintaining data representing a dynamic moving body, the dynamic moving body being divided into cells, and rendering the dynamic moving body from a plurality of observer views. Each observer view is associated with a corresponding observer position, and for each cell, the observer view is associated with a corresponding cell mesh and an associated resolution. The cell mesh associated with the observer view is distinct from cell meshes for the same cell associated with other observer views.

This application also describes improved techniques (including view frustum culling and geometry instancing) for enhancing processing performance in connection with simulating a dynamic moving body. For example, a method for simulating a dynamic moving body includes dividing a dynamic moving body into cells, where each cell is associated with a corresponding mesh having an associated resolution. A master mesh is generated based on a cell mesh geometry of a selected cell. The master mesh for determining a mesh geometry of at least one of the cells is instantiated. A visibility test is applied to determine, for each cell, whether the cell is within a view frustum for the observer. In one embodiment, only cells which are within the view frustum are rendered.

### BRIEF DESCRIPTION OF THE DRAWINGS

The features of the present application can be more readily understood from the following detailed description with reference to the accompanying drawings wherein:

FIG. 1 illustrates a flowchart of a method for simulating a dynamic moving body, according to one embodiment of the present application;

FIG. 2A illustrates a schematic view of a grid structure of 3×2 cells within an exemplary scene including a dynamic moving body;

FIG. 2B illustrates a cell (1, 0) of the grid structure of FIG. 2A;

FIG. 2C illustrates a mesh with a resolution of 8×8, co-located in the cell (1, 0) of FIG. 2B;

FIG. 2D illustrates two meshes with different respective resolutions, including the cell (1, 0) with a mesh resolution of 8×8, and a cell (2, 1) with a mesh resolution of 4×4;

FIG. 2E illustrates a mesh point in the cell (2, 1) of FIG. 2D;

FIG. 2F illustrates a mesh facet in the cell (2, 1) of FIG. 2D;

FIGS. 3A and 3B illustrate schematic diagrams illustrating construction of a column of triangles to stitch a mesh to its east neighbor, in which the east neighbor has a higher resolution than the mesh, according to one embodiment of the present disclosure;

FIGS. 4A and 4B illustrate schematic diagrams illustrating construction of a column of triangles to stitch a mesh to its east neighbor, according to another embodiment, in which the east neighbor has a lower resolution than the mesh;

FIGS. 5A and 5B illustrate schematic diagrams illustrating construction of a row of triangles to stitch a mesh to its north neighbor, in which the north neighbor has a higher resolution than the mesh, according to one embodiment;

FIGS. 6A and 6B illustrate schematic diagrams illustrating construction of a row of triangles to stitch a mesh to its north neighbor, according to another embodiment, in which the north neighbor has a lower resolution than the mesh;

FIGS. 7A and 7B illustrate schematic diagrams illustrating stitching of an upper right corner of a mesh to its east and north neighbors, in which the east and north neighbors have higher resolutions than the mesh, according to one embodiment;

FIGS. 8A and 8B illustrate schematic diagrams illustrating stitching of an upper right corner of a mesh to its east and north neighbors, according to another embodiment, in which the east and north neighbors have lower resolutions than the mesh;

FIG. 9 is a flowchart illustrating an exemplary embodiment of a method for visually simulating a dynamic moving body from multiple observer views; and

FIG. 10 is a flowchart illustrating a method for simulating a dynamic moving body according to another exemplary embodiment.

### DETAILED DESCRIPTION OF THE DRAWINGS

The present disclosure provides tools for simulating a dynamic moving body, including improved methodologies for managing paging of geometry, minimizing memory requirements, selecting levels of detail for cells, selecting levels of detail for mesh geometry, culling cells to the view frustum, and mesh stripping. The tools may be embodied in a computer program (or a module of instructions to which the computer responds) stored on a computer readable medium, such as a compact disc (CD), and/or transmitted via a computer network, such as the Internet, or another transmission medium, such as a wireless medium, in one or more segments.

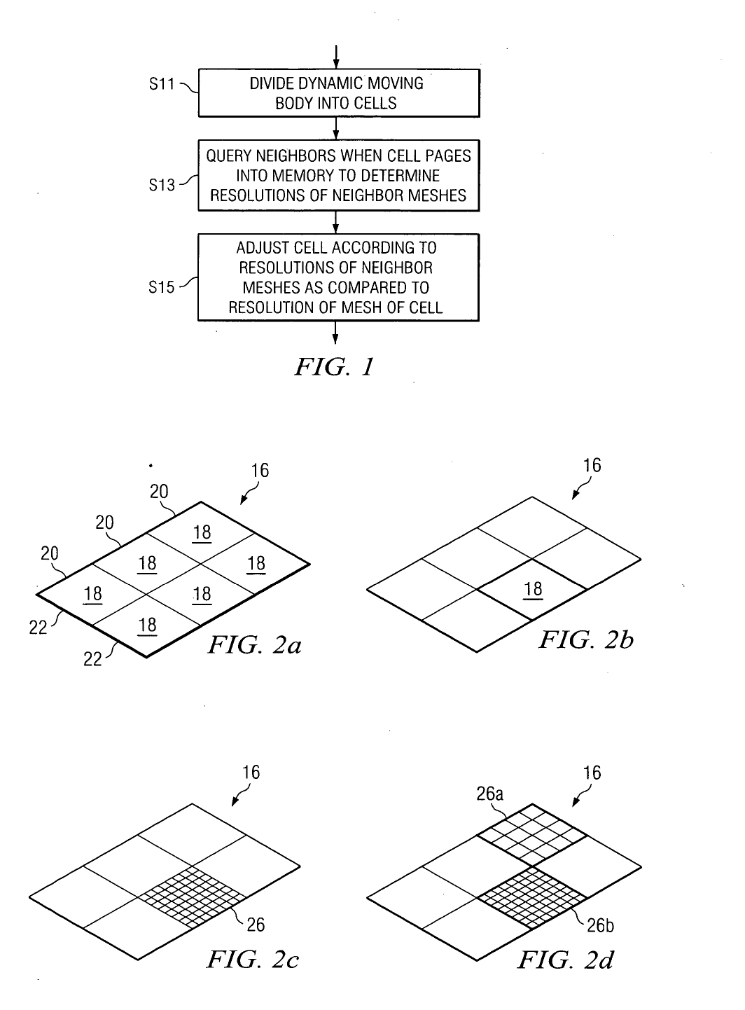

FIG. 1 illustrates a flowchart illustrating a method for simulating a dynamic moving body, according to an exemplary embodiment. The dynamic moving body is divided into a plurality of cells, where each cell is associated with a corresponding mesh having an associated resolution (step S11). Neighbors of a cell are queried when the cell pages into memory to determine resolutions of respective meshes of the neighbors (step S13). The mesh of the cell is adjusted according to a comparison of the resolution of the mesh and the resolutions of the respective meshes of the neighbors (step S15). The mesh of the cell may be adjusted by constructing one or more strips to stitch together the mesh and the neighbors.

The top and right of the mesh of the cell may be adjusted according to a comparison of the resolution of the mesh with resolutions of north and east neighbors, respectively, of the cell. If the resolutions of the mesh and the east neighbor are not the same, one column of triangles may be constructed to stitch together the mesh and the east neighbor. If the resolutions of the mesh and the north neighbor are not the same, one row of triangles is constructed to stitch together the mesh and the north neighbor. When the cell pages out of memory, the cell may reset the east and north neighbors. The cell may also notify west and south neighbors of the cell after the cell pages into memory. When the cell pages out of memory, the cell notifies the west and south neighbors that the cell has paged out.

The bottom and left of the mesh of the cell may be adjusted according to a comparison of the resolution of the mesh with resolutions of south and west neighbors, respectively, of the cell. If the resolutions of the mesh and the west neighbor are not the same, one column of triangles may be constructed to stitch together the mesh and the west neighbor. If the resolutions of the mesh and a south neighbor are not the same, one row of triangles may be constructed to stitch together the mesh and the south neighbor. When the cell pages out of memory, the cell may reset the west and south neighbors. The cell may also notify east and north neighbors of the cell after the cell pages into memory. When the cell pages out of memory, the cell notifies the east and north neighbors that the cell has paged out.

The bottom and right of the mesh of the cell may be adjusted according to a comparison of the resolution of the mesh with resolutions of south and east neighbors, respectively, of the cell. The top and left of the mesh of the cell may be adjusted according to a comparison of the resolution of the mesh with resolutions of north and west neighbors, respectively, of the cell. In addition, each cell may have a geometry instance per each one of a plurality of observers.

A master mesh may be computed for each frame at a highest resolution among the mesh resolutions of the plurality of cells. Positions of vertices in subsequent meshes are sampled from the master mesh. A level of detail may be associated with a corresponding maximum linear distance. If a linear distance from an eyepoint to a cell having a level of detail exceeds the corresponding maximum linear distance, a lower level of detail is selected for the cell.

FIGS. 2A through 2F illustrate example meshes. Some terminology is defined below, with reference to FIGS. 2A through 2F, in the context of simulating ocean water. It should be understood that although exemplary embodiments are described herein with reference to an ocean or simulating ocean water, the tools described herein may be applied to simulate other bodies of water and/or other dynamic moving bodies as well.

An ocean (or another dynamic moving body) may be represented as a grid structure 16, such as a rectangular grid of cells 18. The simulated scene is divided into columns 20 and rows 22 that define the individual cells of the grid (FIG. 2A). Simulated scenes may cover areas larger than a cell by exploiting mesh periodicity.

A cell 18 is a subdivision of the grid structure 16, and may be regarded as an empty location within the definition of the grid structure 16. Each cell 18 has a unique pair of column and row numbers (column, row), which is the address of the cell. The cell 18 is independent of the geometry inside of it, and simply identifies the boundaries and address of a location within the grid structure 16 (FIG. 2B). The cell 18 is a region of a conceptual surface of a simulated scene that corresponds to the surface data (for example, geometry) held in a mesh. Fourier synthesis of the scene may optionally be applied to enable cells 18 to be tiled seamlessly over a larger domain.

A mesh 26 describes the geometry that occupies a corresponding cell 18 of a grid structure 16, and may exist in a runtime scene graph. The mesh 26 is a collection of uniformly spaced, discrete points arranged in a roughly rectangular pattern (FIG. 2C). The points of the mesh 26 correspond to multi-component data elements that may be abstracted from a physical area. Examples of multi-component data elements include height (one dimensional), horizontal position (two dimensional), and normal (three dimensional). Height, position, and normal may be regarded as data outputs of mesh objects. The data output from mesh objects may be associated with a mesh and a co-located cell. The mesh may also include data such as the horizontal width on the x-axis, horizontal length on the y-axis, and number of subdivisions of the mesh.

The horizontal dimensions of the meshes 26 may be constant throughout the grid structure 16, but meshes 26a and 26b may have different resolutions, or levels of detail. The resolution may be a function of range from an actual or virtual observer (FIG. 2D). A mesh point 28 is the smallest indivisible element of a mesh (FIG. 2E), and may be referred to in some instances as a “vertex”. Four mesh points 28 comprise a mesh facet 30 (FIG. 2F). Vertex-to-world space mapping w(v) is accomplished through w(v)=(vx, vy, z(v)), where (vx, vy) are horizontal coordinates of the vertex v (in the master mesh), and z(v) is the height at v.

An observer's position may be used to establish the level of detail (LOD) and optics of a cell. To render a dynamic moving body in an observer's channels (for example, viewports), a scene may be referenced by the observer at an eyepoint of the scene. This may be done regardless of whether the moving body is fixed at a specific location or centered at the observer location.

Features to accommodate multiple observers may be provided. Multiple observers (that is, eyepoints) may be attached to an ocean. If the ocean is referenced by one or more observers, it may be rendered in each of the observers' channels. While the ocean referenced by multiple observers is independent of any one observer with respect to the ocean's position, multiple observers present a unique challenge that an observer-centered ocean does not encounter. That is, each cell's LOD and optics computations are driven by each observer's unique position. For example, observer A is on the deck of an aircraft carrier, 40 feet above the surface of the water, while observer B is in an F-18 jet with a view of the entire ocean from 10,000 feet above the surface of the water. The number of cells which fill the horizontal and vertical field of view of observer A is different from the number for observer B. In addition, the cells for observer B generally require less fidelity (i.e., level of detail) than that of the cells for observer A. Additional features may be provided to accommodate multiple observers, as discussed below.

Paging features may be provided. According to the methodologies of the present disclosure, the per-cell LOD determination, optics computations, and vertex list generation occur in the context of an asynchronous paging thread that synchronizes the construction of cell geometry with a main application thread. Each of the channels associated with an observer may share a pointer to the ocean geometry that corresponds to the observer, and therefore the computation is not required to be on a per-channel basis. Because the geometry of the moving body is generated in an asynchronous thread and the underlying geometry is unique per observer, a cell may include one mesh per observer. The cell's LOD and optics may be unique for each observer. Additional paging features may be provided, as discussed below.

A multiple geometry reference feature may be provided. The mesh may contain a reference to two underlying geometries that enable the geometry to be double buffered. One instance may be rendered during one animation sequence, while the other instance is constructed for the next animation sequence. Additional geometry instancing features may be provided, as discussed below.

View-frustum culling features may be provided. In order for applications to operate at high frame rates, a cell may be view-frustum culled. View-frustum culling is a rendering technique that can be employed by real-time simulation software to operate at high frame rates. A view frustum is defined as the intersection of any suitable number of half-spaces, such as six half-spaces, that define the boundaries of what is visible to the eyepoint. View frustum culling correctly rejects polygons that lie outside of the view frustum, and clips those that straddle the view frustum. If a cell is not completely or only partially within the viewing frustum, then no overhead is incurred to render the cell, and the rendering time may substantially be decreased as a whole. When view frustum culling is performed in an asynchronous process, visibility tests compare geometry against the frame synchronized eyepoint positions, and consequently, the eyepoint's frame synchronized view frustum.

According to one embodiment, culling may be performed before ocean construction. To allow for appropriate culling if the observer moves before the thread has completed processing, movement of the observer may be predicted. For example, heuristics of how fast observer has been translating and rotating may be used to determine the movement. The field of view of each view frustum may be increased to account for rotation, and each ocean cell's bounding sphere may be increased to account for translation. These two modifications, based on heuristic data, may allow for appropriate culling. By performing culling before the ocean construction, a substantial amount of time in the asynchronous thread may be saved.

Real-time simulation systems typically do not employ this technique in an asynchronous process. In addition, conventional simulation techniques do not account for the fact that the construction of dynamic moving bodies of water is a computationally intensive task that, depending on the complexity of the scene graph, may take longer than a single frame to finish. This fact complicates the ability to employ view frustum culling because the eyepoint positions and the eyepoint's frame synchronized view frustum is no longer frame synchronized. Additional view frustum culling features may be provided, as discussed below.

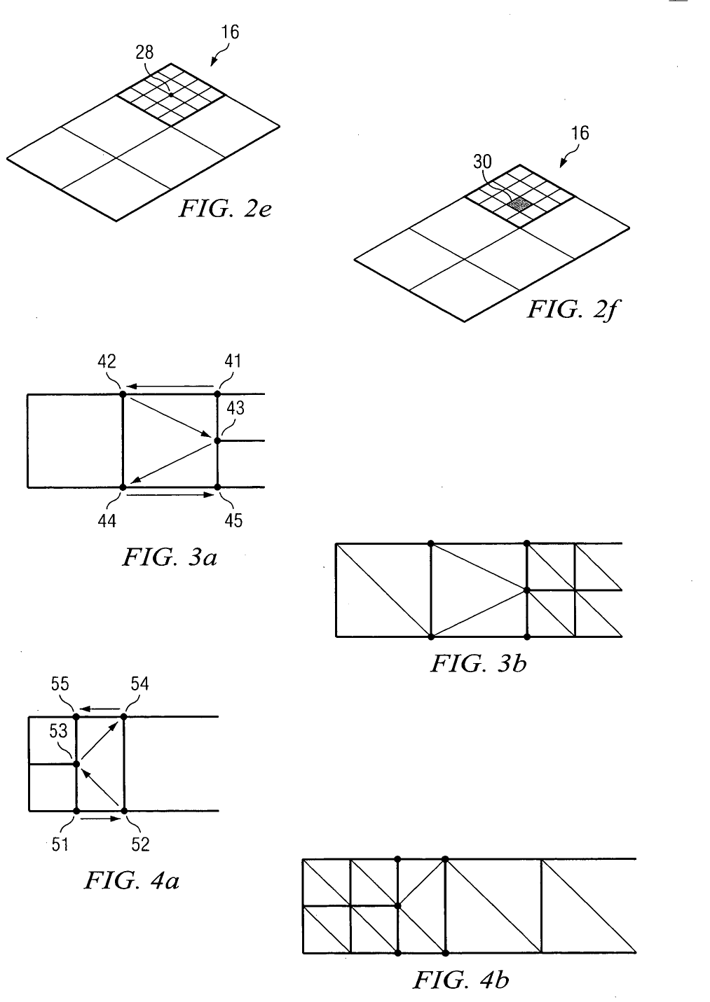

FIGS. 3A through 8B illustrate stitching the mesh to its neighbors. During the stitching process, the resolutions of the mesh and its east neighbor are compared. If the resolutions of the mesh and its east neighbor are the same, adjustive actions is not required. The column of triangles that connects the two meshes is generated at the same resolution, and is added to the first strip.

Although the embodiments described above refer to querying a cell's (or mesh's) east and north neighbors and comparing the resolution of the cell to the resolutions of the east and north neighbors, it should be understood that the query and comparisons may be made with respect alternatively to other equivalent pairs of neighbors, such as the south and the west neighbors, or the south and the east neighbors, or the north and the west neighbors, so long as the selected pair is consistently applied. Thus, reference to the “east neighbor” should be construed to cover the neighbor to the right of the subject cell, or alternatively (and equivalently) the neighbor to the left. Similarly, reference to the “north neighbor” covers the neighbor above the cell, or alternatively (and equivalently) the neighbor below the cell.

According to one embodiment, a cell is aware of the LOD of its underlying geometry, and may be rendered, at least potentially, in a different level of polygonal detail for each frame. For example, the resolution may decrease as the cells extend farther out. In order to maintain coherence between meshes, strips may be stitched between neighboring meshes that have different resolutions. For example, if an east and/or north neighbor cell exists, then the right and/or top of the mesh are stitched correctly to correspond to the resolution of the corresponding neighbor. Otherwise, the right and/or top of the mesh are rendered at the resolution of the cell being examined.

According to one embodiment, the meshes are seamlessly periodic and the horizontal dimensions (i.e., width and length) of the meshes may be constant throughout the grid. The mesh periodicity enables one master mesh to be computed at each frame at the highest resolution specified, and subsequent meshes in the scene graph to have the position of their vertices sampled from the master mesh. The sampling of the master mesh enables each mesh in the scene graph to have potentially a different resolution (or level of detail).

The mesh knows its level of detail and queries its two neighbors (i.e., to the east/right and to the north/above) to obtain information regarding their respective levels of detail. The mesh may maintain the information regarding the neighbors' levels of detail and uses the information in order to stitch the triangles together between the meshes. For example, when a cell pages into memory, the cell queries the east and north cell neighbors, if they exist. The cell can then query the neighbors' respective LODs for each frame, and can notify the west and south neighbors, if they exist, that the cell has just paged in to memory. Conversely, when a cell pages out of memory, the cell resets its east and north neighbors, and notifies the west and south neighbors that the cell has paged out of memory.

According to one embodiment, the resolution of each mesh is a power of two in both directions (i.e., x and y). Levels of detail are cached as integers in powers of two, (1, 2, 4, . . . ), where 1 is associated with the highest detail level (i.e., resolution) at which every vertex is drawn. If the highest resolution of a mesh is 64×64, then a LOD of corresponds to a rendered mesh resolution of 64×64, a LOD of 2 corresponds to a rendered mesh resolution of 32×32, 4 corresponds to a rendered mesh resolution of 16×16, 8 corresponds to a rendered mesh resolution of 8×8, 16 corresponds to a rendered mesh resolution of 4×4, and 32 corresponds to a rendered mesh resolution 2×2.

A mesh having the highest resolution allocates the maximum number of vertices for the LOD. For each frame, the mesh dynamically generates the appropriate number of vertices to fulfill the LOD requirements based on the mesh's LOD and the LODs of the mesh's east and north neighbors. An example LOD requirement may require that no re-allocation of vertex arrays is performed.

The dynamic moving body can be configured to have a vector of switch distances that may indirectly be associated with the levels of detail. Distances are inserted into the vector in ascending order. Zero is inserted, by default, into the vector when the ocean is constructed. Each adjacent pair of numbers represents a range of distances. For example, if every value in the vector is a multiple of 100 (up to 500), then there are six ranges in the vector:
[0]=[0−100)
[1]=[100−200)
[2]=[200−300)
[5]=[500−far clip plane)

The value at each index represents the maximum linear distance that the paging strategy can be from the cell for the cell to be rendered at a certain LOD. Above the maximum distance, the cell's LOD complexity is lowered by a power of 2. Cells that are closer to the eyepoint are triangulated more coarsely than those farther away. The far clip plane is the linear distance from the eyepoint at which the dynamic moving body is no longer visible.

The index of each element in the vector corresponds indirectly to the LOD at which the current mesh is rendered when the paging strategy is within the corresponding range. The index corresponds indirectly to the LOD because the index is used as the exponent for computing the base 2 LOD, in which LOD values are powers of 2. As discussed above, 1 is the highest detail level in which every vertex is drawn. In the example above, the highest detail level of a mesh is 64×64. Since 64=2⁶, a maximum of six levels of detail ranges may be set. Starting at index zero: 2⁰=1, 2¹=2, 2²=4, 2³=8, 2⁴=16, 2⁵=32.

After the level of detail is determined, the remaining rendering tasks include optimizing the number of triangle strips sent down the rendering pipeline and maintaining the continuity between meshes of differing resolution. Maintaining continuity which includes constructing a column of triangles that stitch together the mesh and its east neighbor, a row of triangles that stitch together the mesh and its north neighbor, and a facet in the upper right corner. The patches that stitch together neighbors depend on the resolutions of the neighbors.

Significant performance gains result from organizing triangles into strips. According to one embodiment, the mesh may be rendered as at most four triangle strips. Almost the entire body of the mesh comprises the first strip. The remaining three strips are the right, top, and corner stitchings, respectively. Each column of triangles may optionally be treated as one triangle strip, and vertex data may be generated for each column of triangles. However, in order to optimize the number of commands sent down the rendering pipeline, the columns that comprise the body of the mesh may be organized into one strip.

The body of the mesh may be constructed in the following manner. Starting at the top left corner of the mesh (0, yₘₐₓ), the triangles are drawn down to vertex (0, 0). The next column is then processed starting at (1, yₘₐₓ). After all of the columns are processed, the last vertex generated is the bottom right corner (xₘₐₓ, 0). Values xₘₐₓ and yₘₐₓ represent the maximum resolution of the mesh (less a multiple of the LOD value of the mesh). The subtraction of the multiple of the LOD value enables the construction of the rightmost column and topmost row of triangles to be performed in separate steps. The additional column and row of triangles connects the mesh to its neighbors.

In order to stitch the meshes together, each mesh obtains and/or maintains knowledge of its neighbor's LOD. Further, the triangles may be constructed in a consistent orientation, such as resulting in front-facing triangles. According to some conventional graphics software, polygons whose vertices appear in counterclockwise order on the screen are so-called “front-facing”. Above the water surface none of the back-facing polygons are sent down the rendering pipeline, and therefore the back-facing polygons are not visible.

FIGS. 3A through 8B illustrate specific stitching procedures. If the mesh to the right (i.e., the east neighbor) is at a higher resolution, then the last column of triangles may be constructed as follows. Starting at the top of the mesh, construct the triangle strip in a repeating pattern, as shown in FIGS. 3A and 3B. Vertices (41 through 45) are visited in the order shown in FIG. 3A. As the column of triangles is constructed, the next facet repeats the pattern (i.e., vertices 45 and 44 become vertices 41 and 42, respectively, for the next facet). FIG. 3B shows one facet that stitches together a low-resolution mesh to the high-resolution mesh of its east neighbor, as rendered. The triangle to the right of, and adjacent to, the diagonal of the upper right corner is not constructed until the right corner is stitched in later, because construction of the facet depends on the LOD of the north neighbor as well.

If the mesh of the east neighbor is at a lower resolution, then the last column of triangles may be constructed as follows. Starting at the bottom of the mesh, construct the strip in a repeating pattern as shown in FIGS. 4A and 4B. Vertices (51 through 55) are visited in the order shown in FIG. 4A. As the column of triangles is constructed, the next facet above repeats the pattern (i.e., vertices 55 and 54 become vertices 51 and 52, respectively, for the next facet). FIG. 4B shows one facet that stitches together a high-resolution mesh to the low-resolution mesh of the east neighbor, as rendered. Next, the resolution of the mesh's north neighbor is compared to the mesh's resolution. If the resolutions are the same, no adjustive actions are taken. The row of triangles that connects the two meshes may be generated at the same resolution and added to the first strip.

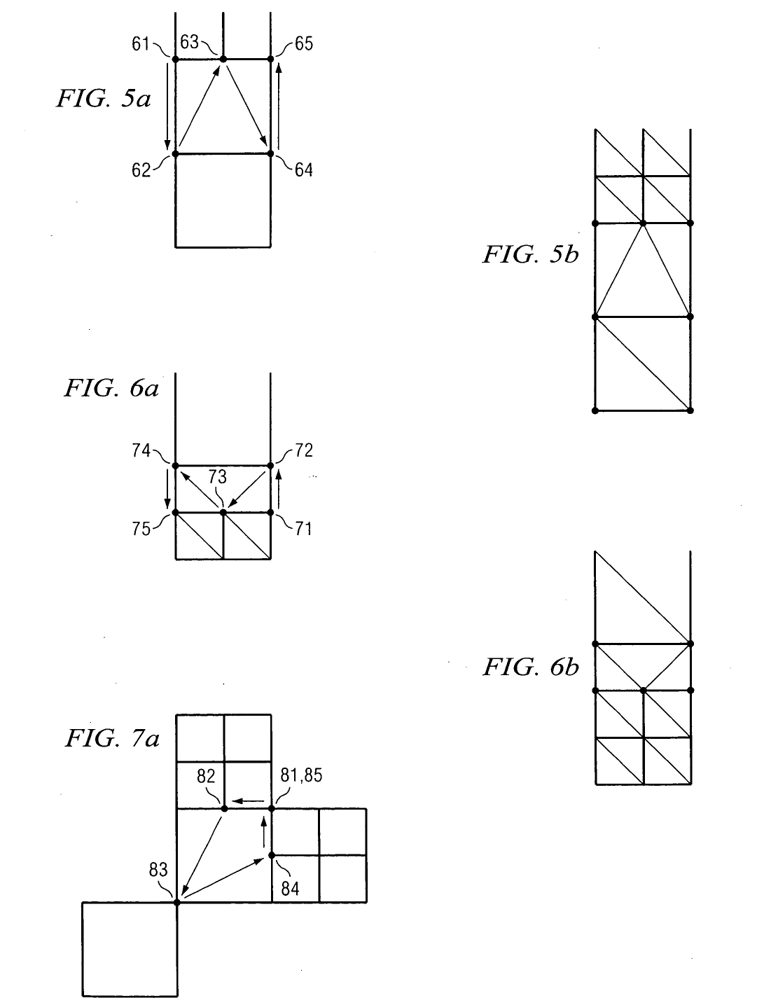

If the mesh above is at a higher resolution, then the top row of triangles is constructed as follows. Starting on the left side of the mesh, construct the strip in a repeating pattern, as shown in FIGS. 5A and 5B. Vertices (61 through 65) are visited in the order shown in FIG. 5A. As the row of triangles is constructed, the next facet to the right repeats the pattern (i.e., vertices 65 and 64 become vertices 61 and 62, respectively, for the next facet). FIG. 5B shows one facet that stitches together a low-resolution mesh to the high-resolution mesh of its north neighbor, as rendered.

If the mesh above is at a lower resolution, then the top row of triangles is constructed as follows. Starting on the right side of the mesh, construct the strip in a repeating pattern, as shown in FIGS. 6A and 6B. Vertices (71 through 75) are visited in the order shown in FIG. 6A. As the row of triangles is constructed, the next facet to the left repeats the pattern (i.e., vertices 75 and 74 become vertices 71 and 72, respectively, for the next facet). FIG. 6B shows one facet that stitches together a high-resolution mesh to the low-resolution mesh of its north neighbor, as rendered. The triangle to the left of, and adjacent to, the diagonal of the upper right corner is not constructed until the right corner is stitched in later, because construction of the facet depends on the east neighbor as well.

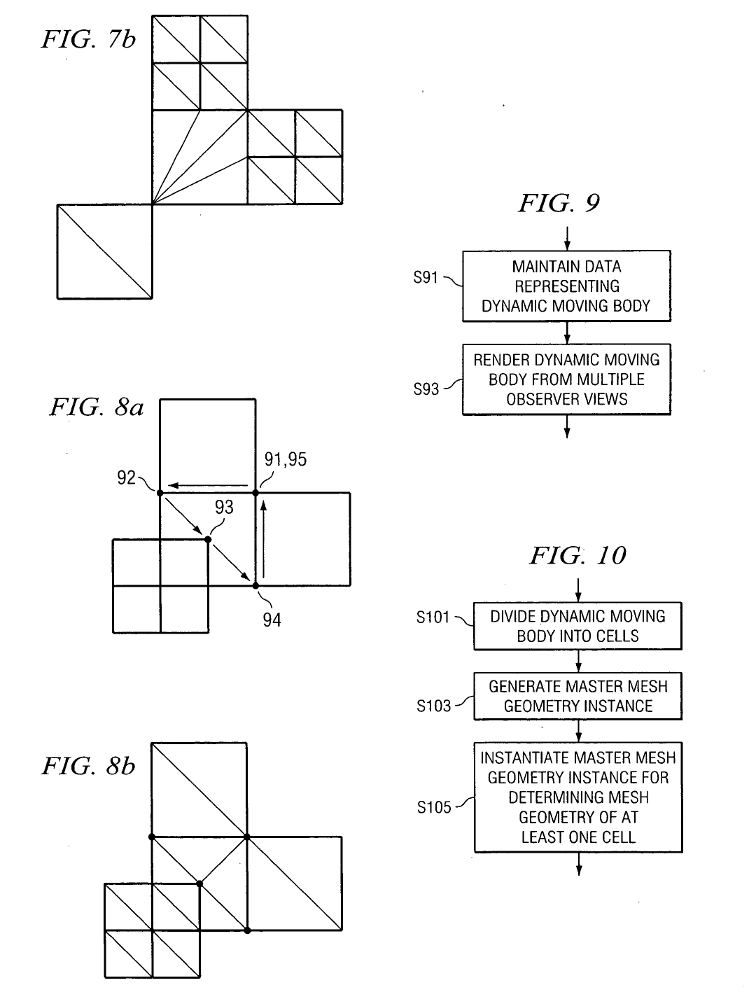

Next, the upper right corner, which is adjacent to both neighbors, is constructed. Regardless of whether the east or north neighbor's resolution is lower or higher, the vertices are visited in the same order. FIGS. 7A, 7B, 8A and 8B illustrate the resulting difference in sampling vertices from the master mesh, based on the LOD of the mesh and the LOD of its two neighbors. As illustrated in FIG. 7 A, both neighboring meshes are at a higher resolution than the current mesh. FIG. 7B shows the corner facet as rendered. As illustrated in FIG. 8A, both neighboring meshes are at a lower resolution than the current mesh. FIG. 8B shows the corner facet as rendered.

The subject matter of this application may be adapted, to allow multiple observers to reference the same, for example, ocean, which is generated by a single wave generator, regardless of whether the ocean is fixed at a specified location, or centered at an observer location. The observer's position affects the level of detail (LOD) and optics of each cell. Each of the referencing observer's channels shares the ocean's geometry.

FIG. 9 is a flowchart illustrating an exemplary embodiment of a method for visually simulating a dynamic moving body from multiple observer views. According to one embodiment, culling may be performed before ocean construction. By performing culling before the ocean construction, a substantial amount of time in the asynchronous thread may be saved. To allow for appropriate culling if the observer moves before the thread has completed processing, movement of the observer may be predicted. For example, heuristics of how fast observer has been translating and rotating may be used to determine the movement. The field of view of each view frustum may be increased to account for rotation, and each ocean bounding sphere may be increased to account for translation. These two modifications, based on heuristic data, may allow for appropriate culling.

According to the illustrated embodiment, data representing a dynamic moving body is maintained, where the dynamic moving body is divided into a plurality of cells (step S91). The dynamic moving body is rendered in real time from a plurality of observer views by using the data representing the dynamic moving body (step S31). Each observer view is associated with a corresponding observer position. For each cell, the observer view is associated with a corresponding cell mesh and an associated resolution. The cell mesh associated with the observer view is distinct from cell meshes for the same cell associated with other observer views.

The method may further comprise determining selected ones of the cells to page in or page out for an observer view, based on a paging strategy for the observer view, where the plurality of observer views are associated with corresponding paging strategies. The paging strategy for the observer view may apply a concentric ring check, starting with a cell containing the observer position, to determine the selected cells to page in. The paging strategy for the associated observer view may include a paging status map that identifies the selected cells currently paged in for the observer view. Each observer view may be associated with a view radius, where the view radius is used to determine whether a cell is within range of the observer position. The cells selected to page in or page out for the observer view may be determined based on the current observer position and the view radius. The paging strategy may be performed through an asynchronous thread independent of the rendering thread.

The method may further comprise determining whether a cell is within a view frustum associated with the observer view, determining whether the cell is within range of the observer position, and paging in the cell for the current observer view if the cell is: (i) within the view frustum associated with the observer view; and (ii) within range of the observer position. The cell may be paged out for the observer view if the cell is not within range of the observer position or is not within the view frustum, and the paged out cell is not rendered for the current observer view.

The method may further comprise modifying the view frustum according to observer movement. The observer movement can include a change to observer position and/or observer orientation. The method may further include modifying the size of the view frustum in accordance with a comparison of a rendering rate to a rate of change of the dynamic moving body.

According to one embodiment, the moving body may comprise an ocean. The ocean may be represented with one or more paging strategies. Each paging strategy is associated with each unique observer that references the ocean. The ocean is referenced by one or more observers in order for the ocean to be rendered in the observers' channels, regardless of whether it is fixed at a specified location or centered at an observer location. When the ocean is rendered, it associates the channel in which it is to be rendered with the correct observer that owns that channel. Based upon that observer, the mesh that contains the underlying geometry of the cell is then selected and rendered.

When an ocean is centered at an observer location, the ocean is not tethered to any one observer, and thus does not move with each observer. For each observer, the paging strategy that corresponds to the observer ensures enough cells are paged into the scene graph to fill the observer's paging range. In the context of an observer-centered ocean, the ocean's far clip plane is the radius of the paging range that surrounds the observer, where the area specified by the radius is filled with cells. A cell may be rendered only if the center of the cell is within the radius. Since a portion of the cell may be beyond the radius, the overall extent of the ocean may be greater than the specified radius.

As the observer's position changes, the position remains surrounded by ocean water. Two separate observers (e.g., one in a helicopter and one on a ship) can reference the same observer-centered ocean. When they are far apart, the observers remain surrounded by ocean water and their cells are generated by the same wave generator. For example, when the helicopter moves within the proximity of the ship, cells that are visible to both observers are shared between the observers. In this scenario, separate oceans are not required, and no additional adjustment is required to join the ocean surfaces, because the same ocean surface is involved. The underlying geometry rendered in each observer's channel, however, is unique to each observer, i.e., the level of detail and the optics are unique for that observer.

View frustum culling and geometry instancing enhance the CPU's performance and allow rendering of an ocean in multiple observers' views to be optimized. View frustum culling, in particular, is particularly helpful for real-time ocean simulation software with multiple views.

A visibility or cull test may substantially reduce the total number of cells that are marked as either paged in or need to be paged, and reduce the number of ocean cells that are constructed. This optimization reduces the overall amount of time required and RAM consumed to create the ocean, to add the new ocean to the scene graph, and to perform the normal frame accurate cull test.

Specifically, the view-frustum culling strategy computes one or more view frustums to check each cell against the field of view for this update cycle. The computations are performed in world space. The view frustums are cached in world space because subsequent visibility tests compare a position in world space against the frustums. A view frustum is cached for each channel that is attached to the observer. Cells that are within range of the strategy are then tested against the computed frustums.

The construction of the ocean and these comparisons are performed asynchronously from the application thread, and therefore the size of each frustum may be modified (widened or narrowed) to compensate for observer movement that may happen before the ocean is updated again. The frustum size may be adjusted because visibility tests do not compare cell positions against the frame synchronized observer position, and consequently, its frame synchronized view frustums. The construction may take into account the observer's movement and frame latency of a multi-stage scene graph rendering pipeline. Heuristic data may be used to account for the observer's position and orientation changes that may occur while a given constructed ocean representation is being viewed. The frame latency of a multi-stage scene graph rendering pipeline may be taken into account through an extra threshold factor when modifying the view frustums and bounding spheres.

According to one embodiment, a paging strategy may be performed. According to the embodiment, if an observer is within the coverage of the ocean, the address of the cell which contains the observer is queried. If the observer is outside of the coverage, it queries the address of the cell that is closest to the observer. If the strategy is within range of the closest cell (i.e., the distance is less than the ocean's far clip plane value) and the cell is visible (i.e., within the viewing frustum(s)), the strategy requests that the cell be paged in.

A concentric ring check is performed out from and around the closest cell (the origin cell) to determine the cells that are in range. Even if the strategy is in the same cell as during the last update cycle, the concentric ring check is performed since the observer's orientation may have changed, which may change the results of frustum culling. During the concentric ring check, cells that are visible and within range are requested to be paged in or to remain paged in. Cells that are in the paging status map (from the previous update cycle) that are not visible or in range are paged out. As soon as a ring is reached which has no cells in range, the concentric ring check terminates. After the paging calculations are performed (and entries in the paging status map have been made), the strategy constructs the underlying geometry of each active cell.

According to one embodiment, a visibility test may be performed. The visibility test verifies that an ocean cell, based on its location and size, might be visible over the next few frames. The test uses the observer's position, orientation, view frustum(s), and heuristic velocity information to make the determination. The visibility test performs a modified bounding sphere comparison. A bounding sphere is a hypothetical sphere that completely encompasses an object. It is defined by a 3D coordinate representing the center of the sphere, and a scalar radius that defines the maximum distance from the center of the sphere to any point in the object. In this case, the radius of the bounding sphere is half of the diagonal size of the mesh plus a scalar to account for the observer's heuristic translational velocity.

The size of the radius may be scaled dynamically to account for the observer's motion. The amount the observer has heuristically been translating from one update to the next (times a factor that accounts for rendering latency) is the amount the bounding sphere is increased. This accounts for the worst possible case where the observer is moving in one direction, but looking at a 90 degree angle to that direction.

Only cells that are visible may be paged into the scene graph. The visibility test examines each of the frustum's six planes, and inserts the center of the cell into the corresponding plane equation, Ax+By+Cz=D, where [ABC] is the normal and the cell's center is [xyz]. D is the orthogonal distance from the cell's center to the plane. The normal of a frustum plane points outside the frustum. Thus, if D is positive, then the point is on the positive side of the plane (outside the frustum). Otherwise, if D is negative, then the point is inside the frustum. If D is positive (outside of the frustum) then the radius of the cell is tested against D to determine if the cell is partially within the frustum. It should be appreciated that other techniques for determining whether a cell is within the view frustum may also be used.

Performing view frustum culling prior to constructing the ocean may provide optimization when there are many (for example, hundreds, thousands, etc.) cells. The construction overhead incurred is a fraction of the overhead incurred without performing the visibility tests. The cells that are constructed may be culled a second time by the regular cull thread to insure that the minimal amount of geometry is sent down the rendering pipeline.

FIG. 10 is a flowchart illustrating a method for simulating a dynamic moving body according to another exemplary embodiment. A dynamic moving body is divided into a plurality of cells, where each cell is associated with a corresponding mesh having an associated resolution (step S101). A master mesh is generated based on a cell mesh geometry of a selected cell (step S103). The master mesh is instantiated for determining a mesh geometry of at least one of the plurality of cells (step S105). The resolution of the master mesh may be of the highest available resolution. The master mesh includes a plurality of vertices, and the mesh geometry of the at least one of the plurality of cells may be formed with a sample of the plurality of vertices. The sample of the plurality of vertices may be translated or rotated to determine vertices for the mesh geometry of the at least one of the plurality of cells. The resolution of the mesh geometry of the at least one of the plurality of cells may be different from the resolution of the master mesh.

The method may further include querying neighbors of a selected cell in order to determine resolutions of respective meshes of the neighbors. The mesh geometry of the selected cell may be selected according to a comparison of the resolution of the mesh and the resolutions of the respective meshes of the neighbors. In addition, a plurality of permutations of the master mesh may be stored for each level of detail, where each permutation corresponds to an associated combination of neighbor mesh resolutions. The instantiating of the master mesh to determine the mesh geometry of the selected cell may include indexing one of the permutations of the master mesh.

Ocean scenes may be generated using periodic cells, which enables these cells to be tiled seamlessly over a larger domain. A cell is considered periodic if the waves produced by it form a complete cycle at the interval that coincides with the physical dimensions of the cell. Consequently, oceans cover areas larger than a cell by exploiting mesh periodicity.

The mesh periodicity enables one master mesh to be computed at each update cycle at the highest resolution specified, and enables subsequent meshes in the scene graph to have the position of their vertices sampled from the master mesh. The sampling of the master mesh enables each mesh in the scene graph to potentially have a different resolution (level of detail).

Geometry instancing enables one copy or instance of geometry to be rendered multiple times per frame, typically in different locations. For example, an application may have many trees that are identical, except for their location. In the example, instancing involves constructing (allocating and computing vertices, colors, and texture coordinates) one tree, and then attaching the tree at different transforms in the scene graph to place the tree in different locations in the scene.

The mesh knows its level of detail (LOD) and that of its two neighbors (to the east and to the north) in order to stitch the triangles together between the meshes. Once a mesh's view-dependent resolution is computed and constructed (including its east and north stitching), it can be instanced like the tree in the example above, provided: (i) the base, water surface has not been affected by ship phenomena such as a bow waves or Kelvin wake; and (ii) there are no view dependent optics calculations performed on the CPU on each mesh. In this case, the unique geometry cannot be replicated anywhere else in the domain. As a result, instancing relieves the application from computing each and every vertex in the ocean at every update cycle.

Because of the stitching that may exist between a mesh's east and north neighbor, there can be many permutations of a mesh at each level of detail. For each resolution, there can be several different permutations, including the following:
the resolution of both neighbors is identical to the mesh's resolution;
the resolution of both neighbors is one magnitude lower than that of the mesh;
the resolution of both neighbors is one magnitude higher than that of the mesh;
the resolution of the east neighbor is one magnitude higher than that of the mesh, while the resolution of the north neighbor is identical to the mesh's resolution;
the resolution of the east neighbor is one magnitude lower than that of the mesh, while the resolution of the north neighbor is identical to the mesh's resolution;
the resolution of the east neighbor is one magnitude higher than that of the mesh, while the resolution of the north neighbor is one magnitude lower than that of the mesh;
the resolution of the east neighbor is one magnitude lower than that of the mesh, while the resolution of the north neighbor is one magnitude higher than that of the mesh;
the resolution of the north neighbor is one magnitude higher than that of the mesh, while the resolution of the east neighbor is identical to the mesh's resolution; and
the resolution of the north neighbor is one magnitude lower than that of the mesh, while the resolution of the east neighbor is identical to the mesh's resolution.

Each permutation of the geometry may be cached separately. For example, a unique key may be generated for each permutation, which uniquely determines the geometry that is instanced. Construction of permutations may be limited to permutations that are visible.

An exemplary key can be created as follows (although it should be appreciated that a key can be calculated using a different technique which yields unique keys): key=(meshLOD*1000000)+(northNeighborLOD*1000)+(eastNeighborLOD).

The key is used in the following process to compute each mesh for each update cycle. According to the process, the key is computed, and the factory that constructs the geometry is queried to see if a geometry instance matches the key. If there is a match, then the mesh sets its geometry pointer point to this instance, thereby avoiding the overhead incurred in constructing the geometry. The mesh also sets the flag denoting that this mesh did not construct and, as a result, does not own this geometry. If there is no match, then a geometry instance is allocated (or obtained) from the geometry factory and is assigned to the inactive geometry pointer. Moreover, the geometry for this LOD and requisite stitching is computed and a flag denoting that this mesh was constructed and, as a result, owns this geometry is set. The factory that constructs the geometry is associated with a copy of the pointer to this newly constructed geometry and its corresponding key so future meshes can instance this geometry. The geometry factory owns the map of keys and geometry instances. It clears this map at the beginning of every update cycle. The map is filled as meshes provide the factory newly computed instances and their corresponding keys.

This mechanism for geometry instancing has some profound performance enhancements. A small fraction of the total number of meshes typically gets created, thus saving substantial amounts of CPU cycles. Because a mesh is typically rendered many times, it can be stored as a display list on the graphics hardware. Without using display lists, every vertex for every mesh is sent to the graphics pipe every frame. With instancing, only the unique meshes are send down the graphics pipeline, yet they are rendered in multiple locations in world space.

This disclosure introduces new techniques for rendering an observer-centered ocean in multiple views, managing paging of geometry, minimizing memory requirements, culling cells to the view frustum prior to construction of the cells, and geometry instancing. The techniques described herein may be used to produce optimal meshes of varying polygonal density, where the density is view dependent. The logic may be performed at run-time and does not rely on a pre-defined multi-resolution representation from which to build the adaptive meshes of each frame. Moreover, the logic accounts for multiple view-dependent metrics, ensures frame-to-frame coherence while operating at consistent, high frame rates and rendering thousands of meshes per frame, and prevents discontinuities or cracks from appearing between meshes rendered at different resolutions.

The above specific embodiments are illustrative, and many variations can be introduced on these embodiments without departing from the spirit of the disclosure or from the scope of the appended claims. Elements and/or features of different illustrative embodiments may be combined with each other and/or substituted for each other within the scope of the present disclosure and appended claims. For example, the representations of levels of detail and how they are translated to resolutions may be different. In addition, the way manner in which the vector of switch distances is cached and processed, and how the values ultimately affect the LOD selection may vary. Further, as should be apparent to one skilled in the art, the underlying geometry of the meshes may be constructed in multiple asynchronous threads.

What is claimed is:

1. A method for visually simulating a moving body from a plurality of observer views, comprising:
maintaining data representing a moving body, the data comprising a plurality of cells, a cell associated with one or more cell meshes; and
rendering in real time the dynamic moving body from a plurality of observer views according to the data representing the dynamic moving body, an observer view associated with a corresponding observer position, a corresponding cell mesh, and an associated resolution, a cell mesh associated with an observer view for a cell being distinct from one or more other cell meshes associated with other observer views for the cell.

2. The method of claim 1, further comprising determining selected ones of the cells to page in or page out for an observer view in accordance with a paging strategy associated with the observer view, the plurality of observer views associated with one or more corresponding paging strategies.

3. The method of claim 1, further comprising determining selected ones of the cells to page in or page out for an observer view in accordance with a paging strategy, the paging strategy applying a concentric ring check to determine the selected cells to page in, starting with a cell comprising the observer position.

4. The method of claim 1, further comprising determining selected ones of the cells to page in or page out for an observer view in accordance with a paging strategy performed through an asynchronous thread independent of a rendering thread.

5. The method of claim 1, further comprising determining selected ones of the cells to page in or page out for an observer view in accordance with a paging strategy, the paging strategy comprising a paging status map that identifies the selected cells currently paged in for the observer view.

6. The method of claim 1, further comprising determining selected ones of the cells to page in or page out for an observer view in accordance with the current observer position and a view radius associated with the observer view, the view radius defining whether a cell is within range of the observer position.

7. The method of claim 1, further comprising:
determining whether a cell is within a view frustum associated with the observer view, the view frustum related to the observer position and an observer orientation;
determining whether the cell is within range of the observer position; and
paging in the cell for the current observer view if the cell is within the view frustum and within range of the observer position.

8. A program storage device readable by a machine, tangibly embodying a program of instructions executable by the machine to perform the method claimed in claim 1.

9. A computer data signal transmitted in one or more segments in a transmission medium which embodies instructions executable by a computer to perform the method claimed in claim 1.

10. A computer system, comprising:
a processor; and
a program storage device readable by the computer system, tangibly embodying a program of instructions executable by the processor to perform the method claimed in claim 1.

11. A method for simulating a moving body, said method comprising:
dividing a representation of a dynamic moving body into a plurality of cells, each cell associated with a corresponding mesh having an associated resolution;
generating a master mesh in accordance with a mesh geometry of a selected cell; and
instantiating the master mesh for determining a mesh geometry of at least one cell of the plurality of cells.

12. The method of claim 11, wherein a resolution of the master mesh is the highest available resolution.

13. The method of claim 12, wherein a resolution of a mesh geometry of the at least one cell is different the resolution of the master mesh.

14. The method of claim 11, wherein the master mesh comprises a plurality of vertices, the mesh geometry of the at least one cell formed with a sample of the plurality of vertices.

15. The method of claim 11, wherein the master mesh comprises a plurality of vertices, the mesh geometry of the at least one cell formed with a sample of the plurality of vertices, the sample of the plurality of vertices translated or rotated to determine vertices for the mesh geometry.

16. The method of claim 11, further comprising:
querying one or more neighbor cells of the selected cell to determine a resolution of a respective mesh for each of the one or more neighbor cells;
comparing the resolution of the mesh and the resolutions of the respective meshes of the one or more neighbor cells; and
selecting the mesh geometry of the selected cell in accordance with the comparison.

17. The method of claim 16, further comprising:
establishing a plurality of permutations of the master mesh for each of one or more levels of detail, a permutation corresponding to an associated combination of at least some of the resolutions of the respective meshes of the one or more neighbor cells.

18. The method of claim 16, wherein instantiating the master mesh to determine the mesh geometry of the selected cell further comprises:
indexing one of a plurality of permutations of the master mesh for each of one or more levels of detail, a permutation corresponding to an associated combination of at least some of the resolutions of the respective meshes of the one or more neighbor cells.

19. A program storage device readable by a machine, tangibly embodying a program of instructions executable by the machine to perform the method claimed in claim 11.

20. A computer data signal transmitted in one or more segments in a transmission medium which embodies instructions executable by a computer to perform the method claimed in claim 11.

21. A computer system, comprising:
a processor; and
a program storage device readable by the computer system, tangibly embodying a program of instructions executable by the processor to perform the method claimed in claim 11.

22. A method for simulating a moving body, comprising:
maintaining data representing a moving body, the data comprising a plurality of cells;
performing the following for one or more observers of the moving body to establish one or more view frustums:
predicting movement of an observer of the one or more observers; and
establishing a view frustum operable to accommodate the predicted movement of the observer, the view frustum defining a visible portion of the moving body visible to an eyepoint of the observer;
culling the plurality of cells in accordance with the one or more view frustums; and
generating a scene of the moving body according to the culled plurality of cells.

23. The method of claim 22, wherein predicting movement of an observer of the one or more observers further comprises:
establishing previous movement of the observer; and
predicting the movement of the observer according to the previous movement of the observer.

24. The method of claim 22, wherein:
predicting movement of an observer of the one or more observers further comprises predicting a rotational movement of the observer; and
establishing a view frustum operable to accommodate the predicted movement of the observer further comprises adjusting a field of view associated with the observer to accommodate the rotational movement.

25. The method of claim 22, wherein:
predicting movement of an observer of the one or more observers further comprises predicting a translational movement of the observer; and
establishing a view frustum operable to accommodate the predicted movement of the observe further comprises adjusting a plurality of bounding spheres associated with each of each ocean to accommodate the translational movement.

26. A program storage device readable by a machine, tangibly embodying a program of instructions executable by the machine to perform the method claimed in claim 22.

27. A computer data signal transmitted in one or more segments in a transmission medium which embodies instructions executable by a computer to perform the method claimed in claim 22.

28. A computer system, comprising:
a processor; and
a program storage device readable by the computer system, tangibly embodying a program of instructions executable by the processor to perform the method claimed in claim 22.

29. A method for simulating a moving body, comprising:
maintaining data representing a moving body, the data comprising a plurality of cells, a cell associated with one or more cell meshes, a cell mesh corresponding to an observer view;
determining whether a geometry instance for a target cell mesh is within a view frustum of the corresponding observer view;
establishing whether the geometry instance is available from a geometry factory; and
utilizing the geometry instance to generate a scene of the moving body if the geometry instance is available.

30. The method of claim 1, wherein establishing whether the geometry instance is available from a geometry factory further comprises:
determining a target resolution of the target cell mesh;
determining a neighbor resolution of each of one or more neighbor cell meshes to yield one or more neighbor resolutions; and
establishing whether the geometry instance is available in accordance with the target resolution and the one or more neighbor resolutions.

31. The method of claim 1, wherein establishing whether the geometry instance is available from a geometry factory further comprises:
determining a permutation describing:
a target resolution of the target cell mesh;
a neighbor resolution of each of one or more neighbor cell meshes;
generating a key corresponding to the permutation; and
establishing whether the geometry instance is available in accordance with the key.

32. The method of claim 1, wherein utilizing the geometry instance to generate a scene of the moving body if the geometry instance is available further comprises:
setting a pointer to the geometry instance, the pointer indicating that the geometry instance is to be used to generate the scene.

33. A program storage device readable by a machine, tangibly embodying a program of instructions executable by the machine to perform the method claimed in claim 29.

34. A computer data signal transmitted in one or more segments in a transmission medium which embodies instructions executable by a computer to perform the method claimed in claim 29.

35. A computer system, comprising:
a processor; and
a program storage device readable by the computer system, tangibly embodying a program of instructions executable by the processor to perform the method claimed in claim 29.
